(19) United States
(12) Patent Application Publication
(10) Pub. No.: US 2018/0349071 A1
(43) Pub. Date: Dec. 6, 2018

(54) IMAGE FORMING APPARATUS MANAGEMENT SYSTEM INCLUDING PLURAL IMAGE FORMING APPARATUSES AND MANAGEMENT SERVER FOR REMOTELY MANAGING PLURAL IMAGE FORMING APPARATUSES VIA NETWORK, AND IMAGE FORMING APPARATUS MANAGEMENT METHOD

(71) Applicant: KYOCERA Document Solutions Inc., Osaka (JP)

(72) Inventor: Takumi NAKAMURA, Osaka (JP)

(73) Assignee: KYOCERA Document Solutions Inc., Osaka (JP)

(21) Appl. No.: 15/992,190

(22) Filed: May 30, 2018

(30) Foreign Application Priority Data
May 30, 2017 (JP) 2017-106449

(51) Int. Cl. G06F 3/12

(52) U.S. Cl. CPC G06F 3/1209; G06F 3/1285; G06F 3/1224; G06F 3/1294

(57) ABSTRACT

Provided is a management system that, recovers the image forming apparatus to being online by remote control from the management server. The image forming apparatus management system includes a message-receiving apparatus for receiving control instructions from the management server via a communication path (mobile telephone network) that is separate from a network. The management server detects an image forming apparatus of which the connection with a server-communication unit becomes offline as an offline apparatus. Then, the management server transmits a control instruction to the message-receiving apparatus via the communication path for causing the offline apparatus to recover the connection with the server-communication unit to online. The management-target image forming apparatuses are connected to the message-receiving apparatus, and based on control instruction received by the message-receiving apparatus, communicate with the server-communication unit via the network and recovers the connection to online.

### INCORPORATION BY REFERENCE

This application is based on and claims the benefit of priority from Japanese Patent Application No. 2017-106449 filed on May 30, 2017, the contents of which are hereby incorporated by reference.

### BACKGROUND

The present disclosure relates to an image forming apparatus management system that includes plural image forming apparatuses and a management server that remotely manages the plural image forming apparatuses via a network, and relates to an image forming apparatus management method.

In recent years, remote management of plural image forming apparatuses in a customer environment by a management server is being performed. When the state of a network becomes unstable, or when the electric power supply is turned OFF, an image forming apparatus becomes offline, which the connection with the management server is in a disconnected state.

The management server is not able to collect counter values from or execute remote control of an offline image forming apparatus. Therefore, configuration is such that an image forming apparatus that becomes offline autonomously transmits a request to reconnect with the management server, and returns to being online.

Moreover, when the electric power supply to an image forming apparatus is turned OFF, a request to reconnect cannot be transmitted from the image forming apparatus until the power supply to the image forming apparatus is turned ON, so the image forming apparatus remains offline. Therefore, technology is proposed by which the management server acquires the operating schedule of an image forming apparatus, and outputs a warning when attempting to access the image forming apparatus outside of the operating time.

### SUMMARY

The image forming apparatus management system according to the present disclosure is an image forming apparatus management system that includes plural image forming apparatuses, and a management server that remotely manages, via a network, image forming apparatuses of the plural image forming apparatuses that are registered as management targets. Furthermore, the image forming apparatus management system includes a message-receiving apparatus for receiving control instructions via a communication path that is separate from the network. The management server includes a server-communication unit, an offline-apparatus-detecting unit, and a recovery-requesting unit. The server-communication unit is connected with the management-target image forming apparatuses via the network. The offline-apparatus-detecting unit detects an image forming apparatus of which the connection with the server-communication unit is offline as an offline apparatus. The recovery-requesting unit transmits a control instruction to the message-receiving apparatus via the communication path for causing the offline apparatus detected by the offline-apparatus-detecting unit to recover the connection with the server-communication unit to an online state. The management-target image forming apparatuses are connected to the message-receiving apparatus, and include an apparatus-communication unit that, based on the control instruction that is received by the message-receiving apparatus, communicates with the server-communication unit via the network and recovers the image forming apparatus to an online state.

The image forming apparatus management method according to the present disclosure is an image forming apparatus management method by an image forming apparatus management system that includes plural image forming apparatuses, and a management server that remotely manages, via a network, image forming apparatuses of the plural image forming apparatuses that are registered as management targets. Furthermore, the management server is connected with the management-target image forming apparatuses via the network, and detects an image forming apparatus of which the connection via the network is offline as an offline apparatus. The management server transmits a control instruction to a message-receiving apparatus via a communication path that is separate from the network for causing the offline apparatus detected to recover the connection to an online state. The control instruction is received by the message-receiving apparatus via a communication path that is separate from the network. The management-target image forming apparatuses are connected to the message-receiving apparatus, and based on the control instructions received by the message-receiving apparatus, communicate with the management server via the network and recover the connection state to an online state.

### BRIEF DESCRIPTION OF THE DRAWINGS

FIG. 1 is a configuration diagram that schematically illustrates an image forming apparatus management system of an embodiment according to the present disclosure.

FIG. 2 is an example of a short message that is created by the recovery-request unit illustrated in FIG. 1.

FIG. 3 is a configuration diagram that schematically illustrates the image forming apparatus illustrated in FIG. 1.

FIG. 4 is a flowchart illustrating the flow that is associated with a reconnect request in the offline recovery process of the image forming apparatus management system illustrated in FIG. 1.

FIG. 5 is a flowchart illustrating the flow that is associated with a re-registration request in the offline recovery process of the image forming apparatus management system illustrated in FIG. 1.

### DETAILED DESCRIPTION

In the following, embodiments according to the present disclosure will be explained in detail with reference to the drawings. Incidentally, in the following embodiments, the same reference numbers will be applied to configuration illustrating the same function.

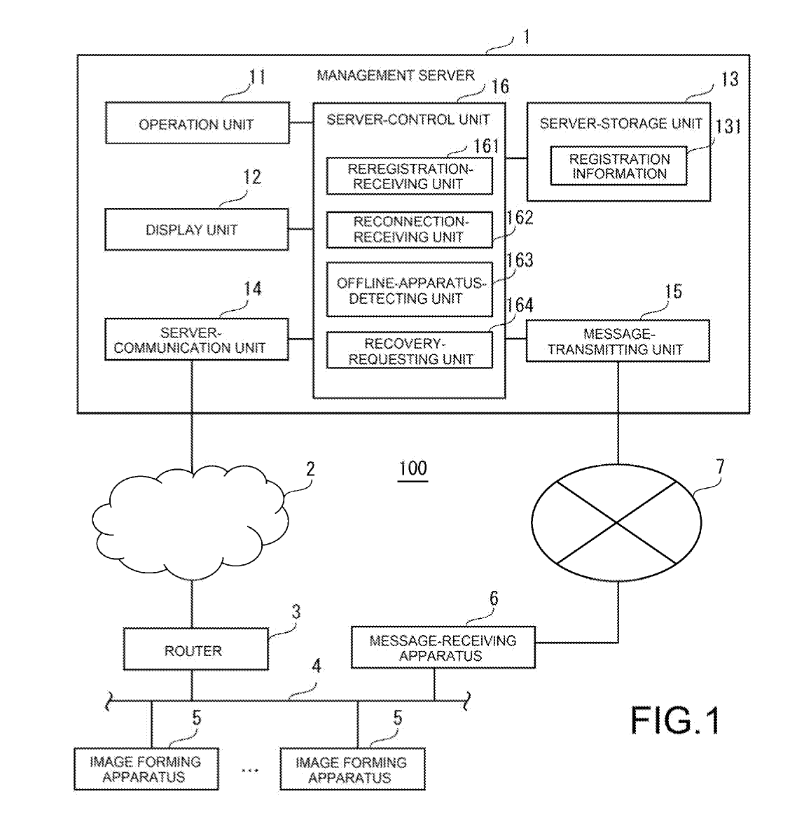

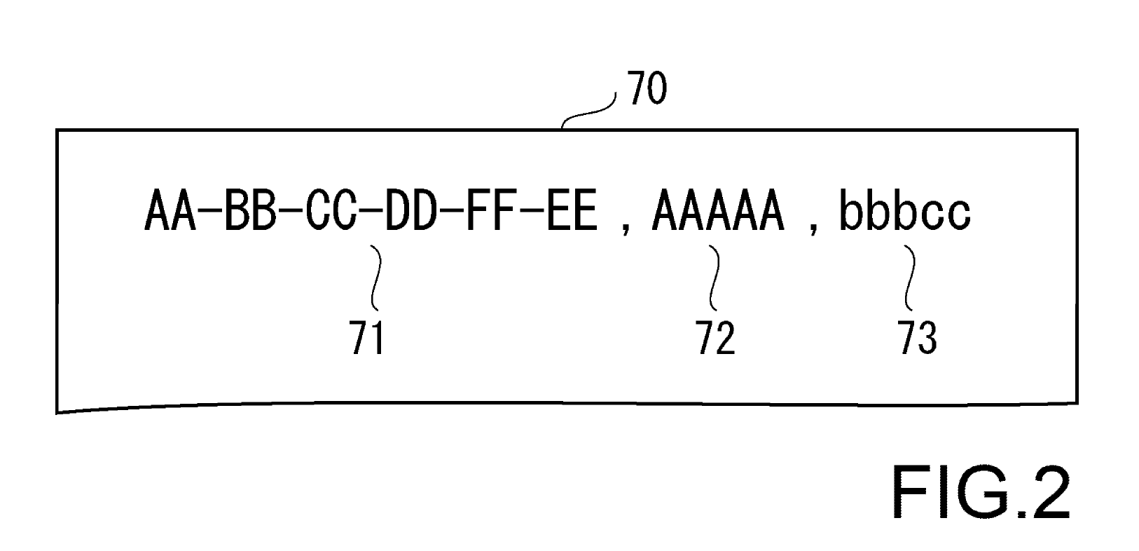

As illustrated in FIG. 1, the image forming apparatus management system 100 of this embodiment includes plural image forming apparatuses 5 in a customer environment, a management server 1, and a message-receiving apparatus 6. The management server 1 remotely manages the management-target image forming apparatuses 5 via a network 2 such as the Internet and the like. The message-receiving apparatus 6 is connected to the customer environment, and via a mobile telephone network 7 that is separate from the network 2, receives short messages 70 (refer to FIG. 2) from the management server 1.

The management server 1 has the function of remotely managing the management-target image forming apparatuses 5 via the network 2 by collecting collection-target data such as error information, various kinds of counter values, toner levels, and the like from, and transmitting control instructions to the image forming apparatuses 5 that are registered as management targets. The management server 1 is a cloud server for example, and includes an operation unit 11, a display unit 12, a server-storage unit 13, a server-communication unit 14, a message-transmitting unit 15, and a server-control unit 16.

The operation unit 11 is an input unit such as a keyboard, mouse or the like. The display unit 12 is a monitor such as a liquid-crystal display or the like, and displays various kinds of information.

The server-storage unit 13 is a storage unit such as a semiconductor memory, HDD (Hard Disk Drive), and the like, and stores registration information 131 in which the management-target image forming apparatuses 5 are registered. In the registration information 131, serial numbers and model names that identify the management-target image forming apparatuses 5, and network information such as IP addresses, MAC addresses and the like are registered together with identification codes 73 for identifying the customer environment (refer to FIG. 2). Moreover, in the registration information 131, the telephone number of a corresponding message-receiving apparatus 6 is correlated with each of the image forming apparatuses 5 in the customer environment and registered. Incidentally, in FIG. 1, only one customer environment is illustrated, however, the management server 1 can remotely manage image forming apparatuses 5 of plural customer environments.

The server-communication unit 14 has the function of transmitting and receiving various kinds of data to and from image forming apparatuses 5 that are connected to a LAN (Local Area Network) of a customer environment via the network 2 and a router 3.

The message-transmitting unit 15 is assigned a telephone number of a mobile telephone line. In addition, the message-transmitting unit 15 has the function of transmitting short messages 70 by a short-message service to other mobile terminals that are assigned telephone numbers of mobile telephone lines via a mobile telephone network 7 that is 3G, LTE, 4G and the like. A short-message service is a service that is capable of transmitting and receiving text messages called short messages 70 by specifying a telephone number of a mobile telephone line.

The server-control unit 16 is connected to each of the operation unit 11, the display unit 12, the server-storage unit 13, the server-communication unit 14 and the message-transmitting unit 15. The server-control unit 16 is an information-processing unit such as a microcomputer or the like that includes a ROM (Read Only Memory), a RAM (Random Access Memory), a CPU (Central Processing Unit), and the like. The ROM stores a control program for performing operation control of the management server 1. The CPU of the server-control unit 16, by reading the control program that is stored in the ROM and expanding the control program in the RAM, performs overall control of the server according to specific instruction information that is inputted from the operation unit 11. Moreover, the server-control unit 16 functions as a reregistration-receiving unit 161, reconnection-receiving unit 162, an offline-apparatus-detecting unit 163, and a recovery-requesting unit 164.

The reregistration-receiving unit 161 has the function of registering an image forming apparatus 5 that has been registered in the registration information 131 as a management target again in the registration information 131 as a management target. More specifically, the reregistration-receiving unit 161, based on a reregistration request from an image forming apparatus 5 that is received by the server-communication unit 14, has the function of registering an image forming apparatus 5 that transmitted the reregistration request in the registration information 131 as a management target. Together with this, the reregistration unit 161 has the function of establishing a connection with the image forming apparatus 5 that transmitted the reregistration request and the server-communication unit 14, and setting the image forming apparatus 5 in an online state. The online state is a state in which a connection is established between the image forming apparatus 5 and the server-communication unit 14.

The reconnection-receiving unit 162 has the function for receiving a connection again with the server-communication unit 14 for an image forming apparatus 5 that is registered in the registration information 131 as a management target. More specifically, the reconnection-receiving unit 162 has the function of establishing a connection between an image forming apparatus 5 that transmitted a reconnection request and the server-communication unit 14, and sets the image forming apparatus 5 to an online state. This is based on a reconnection request that is received by the server-communication unit 14 from an image forming apparatus 5 that is registered in the registration information 131 as a management target.

The offline-apparatus-detecting unit 163 has the function of monitoring the connection states between image forming apparatuses 5 that are registered as management targets and the server-communication unit 14, and detecting an image forming apparatus 5 of which the connection with the server-communication unit 14 is in the offline state as an offline apparatus. The offline state is a state in which the connection between an image forming apparatus 5 and the server-communication unit 14 is disconnected.

The recovery-requesting unit 164 creates a short message 70 for an offline apparatus detected by the offline-apparatus-detecting unit 163 that includes a control instruction 72 for recovering the connected state to an online state with the server-communication unit 14.

For example, the recovery-requesting unit 164 may receive input of a control instruction 72 that is included in a short message 70 from a manager via a web browser or operation unit 11. The manager can specify as a control instruction 72 a reconnection request instruction for causing a reconnection request to be transmitted from an image forming apparatus 5 via the network 2, or a reregistration request instruction for causing a reregistration request to be transmitted from an image forming apparatus 5 via the network 2.

FIG. 2 is an example of the text of a short message 70 that is created by the recovery-requesting unit 164. The short message 70 is a short text message of about 160 half-sized alphanumeric characters. A short message 70 includes specification information 71 for specifying a management-target image forming apparatus 5, control instruction 72, and identification code 73 for identifying the customer environment, and each is separated by commas. The specification information 71 indicates a specific image forming apparatus 5 or an unspecific image forming apparatus 5. When specifying a specific image forming apparatus 5, the serial number, MAC address and the like of the image forming apparatus 5 is included in the specification information 71, and when specifying an unspecific image forming apparatus 5, “ALL”, a blank space or the like is included in the specification information 71. The control instruction 72 may be a control command that indicates a reconnection request or a reregistration request. The identification code 73 is identification information that is assigned to a customer environment to which the offline apparatus belongs. By an offline apparatus transmitting a reconnection request or a reregistration request together with identification code 73 of the customer environment, it becomes easy for the management server 1 to identify the offline apparatus based on the registration information 131.

Incidentally, a case in which a reregistration request becomes necessary, for example, may be a case in which the manager cancels the registration of a management-target image forming apparatus 5 from the registration information 131 by mistake, or the like. When a manager cancels the registration of a management-target image forming apparatus 5 from the registration information 131, a control instruction for cancelling a registration is transmitted to the image forming apparatus 5 via the network 2, and registration as a management target apparatus is cancelled from the registration information 531 by the image forming apparatus 5. In this case, even though the data in the registration information 131 of the management server 1 is recovered, the image forming apparatus 5 of which registration is cancelled remains offline with respect to the management server 1. Therefore, it is necessary to transmit a reregistration request for reregistration from the side of the image forming apparatus 5 of which registration is cancelled to the management server 1 via the network 2, and perform registration by the reregistration-receiving unit 161. After registration is performed by the reregistration-receiving unit 161, a registration-complete notification is transmitted to the image forming apparatus 5 and the image forming apparatus 5 is registered in the registration information 531 as a management target.

The recovery-requesting unit 164 creates a short message 70, and then references the registration information 131, and as the transmission destination, identifies the telephone number of the message-receiving apparatus 6 that is correlated with the image forming apparatus 5 that is the transmission target. Then, the recovery-requesting unit 164 transmits the short message 70 to the identified telephone number of the message-receiving apparatus 6 by the message-transmitting unit 15 via the mobile telephone network 7.

The message-receiving apparatus 6 is assigned a telephone number of a mobile telephone line. The message-receiving apparatus 6 also has the function of receiving the short message 70 via the mobile telephone network 7, and transferring the control instruction 72 (message) that is included in the short message 70 to the image forming apparatus 5 via a customer network 4. In other words, the message-receiving apparatus 6 functions as a kind of protocol-conversion unit that provides an interface for the mobile telephone network 7 to the management server 1, as well as provides an interface for the customer network 4 to the image forming apparatus 5.

The message-receiving apparatus 6, based on the specification information 71 of the transmission-target image forming apparatus 5 that is included in the received short message 70, transfers the control instruction 72 that is based on short message 70 via the customer network 4. When an unspecific image forming apparatus 5 is specified as the transmission target in the short message 70, the message-receiving apparatus 6 transfers the control instruction 72 based on the short message 70 to all of the image forming apparatuses 5 connected to the customer network 4. When a specific image forming apparatus 5 is specified as the transmission target in the short message 70, the message-receiving apparatus 6 transfers the control instruction 72 based on the short message 70 to only the specific image forming apparatus 5 via the customer network 4.

Incidentally, the message-receiving apparatus 6 may be mounted in a router 3, gateway terminal or the like that is connected to the customer network 4. Moreover, a message-receiving apparatus 6 may be mounted in each of the plural image forming apparatuses 5 connected to the customer network 4. In addition, as illustrated in FIG. 1, by using one message-receiving apparatus 6 for each customer environment, it is possible to suppress the contract fee of the mobile telephone line.

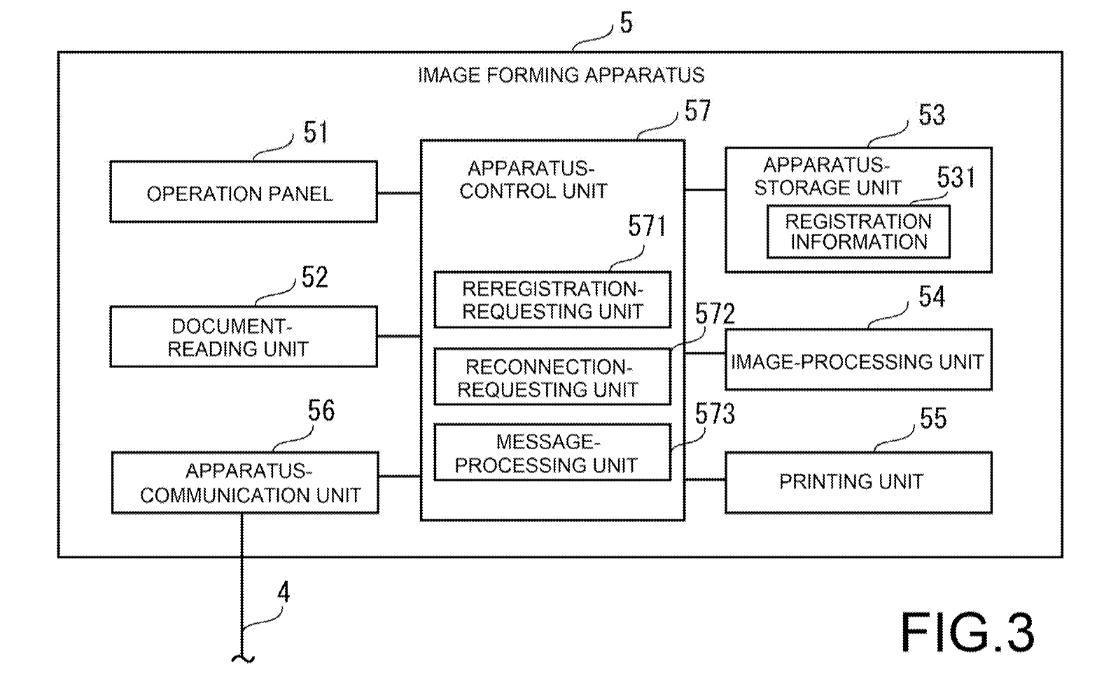

Next the configuration of an image forming apparatus 5 will be explained in detail with reference to FIG. 3. The image forming apparatus 5 is a copier, MFP, or the like and includes an operation panel 51, a document-reading unit 52, an apparatus-storage unit 53, an image-processing unit 54, a printing unit 55, an apparatus-communication unit 56, and an apparatus-control unit 57.

The operation panel 51 is a user interface that includes a touch panel and various operation keys such as a numeric keypad, reset key, stop key, start key, and the like.

The document-reading unit 52 is a scanner that reads a document image by irradiating light onto a document that is supplied by a document-supply apparatus, or onto a document that is placed on the platen glass, and receiving the reflected light and the like.

The apparatus-storage unit 53 is a storage unit such as a semiconductor memory, HDD (Hard Disk Drive) and the like, and image data that is read by the document-reading unit 52, or image data that is received by the apparatus-communication unit 56 is accumulated in the apparatus-storage unit 53. Moreover, the apparatus-storage unit 53 stores registration information 531 in which the registration state of whether or not the image forming apparatus 5 is registered as a management target of the management server 1, the IP address of the management server 1 and the like are registered. The registration information 531 may also be stored in the apparatus-storage unit 53 by a service technician, customer manager, or the like, for example.

The image-processing unit 54 is a processing unit for performing specific image processing on image data; for example, image processing such as enlargement/reduction processing, density adjustment, gradation adjustment, and the like is performed.

The printing unit 55 is a printing unit that prints images on recording paper based on the image data stored in the apparatus-storage unit 53.

The apparatus-communication unit 56 is connected to the customer network 4 by a wired connection or a wireless connection such as Wi-Fi (registered trademark). The apparatus-communication unit 56 also has the functions of transmitting and receiving various kinds of data to and from the management server 1 via the router 3 and network 2, and receiving control instructions 72 based on short messages 70 from the message-receiving apparatus 6 connected to the customer network 4.

The apparatus-control unit 57 is connected to each of the operation panel 51, the document-reading unit 52, the apparatus-storage unit 53, the image-processing unit 54, the printing unit 55 and the apparatus-communication unit 56, and is an information-processing unit such as a microcomputer and the like that includes a CPU, a ROM, a RAM, and the like. The ROM stores a control program for performing operation control of the image forming apparatus 5. The CPU of the apparatus-control unit 57, by reading the control program that is stored in ROM and expanding that control program in RAM, performs overall control of the image forming apparatus 5 according to specific instruction information that is inputted from the operation panel 51. Moreover, the apparatus-control unit 57 functions as a reregistration-requesting unit 571, a reconnection-requesting unit 572 and a message-processing unit 573.

The reregistration-requesting unit 571, by the apparatus-communication unit 56 via the router 3 and network 2, has the function of transmitting a reregistration request to the management server 1 for requesting registering self apparatus as a management target.

The reconnection-requesting unit 572, by the apparatus-communication unit 56 via the router 3 and network 2, has the function of transmitting a reconnection request to the management server 1 for requesting that a connection be established with self apparatus. This is for the case in which, when registered in the registration information 531 as a management target, the connection state between the apparatus-communication unit 56 and the management server 1 is checked, and the connection state is offline. When a reconnection request is repeatedly transmitted to the management server 1 and an online state cannot be recovered even after a specified number of times has been reached, the reconnection-requesting unit 572 extends the transmission retry interval of the reconnection request. In this case, the image forming apparatus 5 is in an offline state for a long period of time. Incidentally, the reregistration-requesting unit 571 and the reconnection-requesting unit 572 can perform transmission according to an operation instruction via the operation panel 51 for a reconnection request or reregistration request. In addition to this, the reregistration-requesting unit 571 and the reconnection-requesting unit 572 can perform autonomous transmission based on specific conditions, can perform transmission based on a control command from the management server 1 in an offline state, and can perform transmission based on a control instruction 72 of a short message 70 described later.

The message-processing unit 573, by the apparatus-communication unit 56, receives a control instruction 72 of a short message 70 that is transferred from the message-receiving apparatus 6 via the customer network 4, determines whether or not execution of a control instruction 72 is necessary, and executes the instruction only when execution is necessary.

For example, in the case of a control instruction 72 related to a reconnection request, the message-processing unit 573 checks whether or not the apparatus-communication unit 56 is online with the management server 1, and when online, determines that execution of the control instruction 72 is not necessary, and deletes the control instruction 72 without executing the instruction. When the apparatus-communication unit 56 is offline with the management server 1, the message-processing unit 573 determines that execution of the control instruction 72 is necessary. Then, by the reconnection-requesting unit 572, causes the apparatus-communication unit 56 to transmit a reconnection request to the management server 1 via the router 3 and network 2.

When the control instruction 72 is related to a reregistration request, the message-processing unit 573 references the registration information 531, and checks whether or not registration as a management target apparatus is cancelled. Then, only when registration is cancelled, by the reregistration-requesting unit 571, causes the apparatus-communication unit 56 to transmit a reregistration request to the management server 1 via the router 3 and network 2.

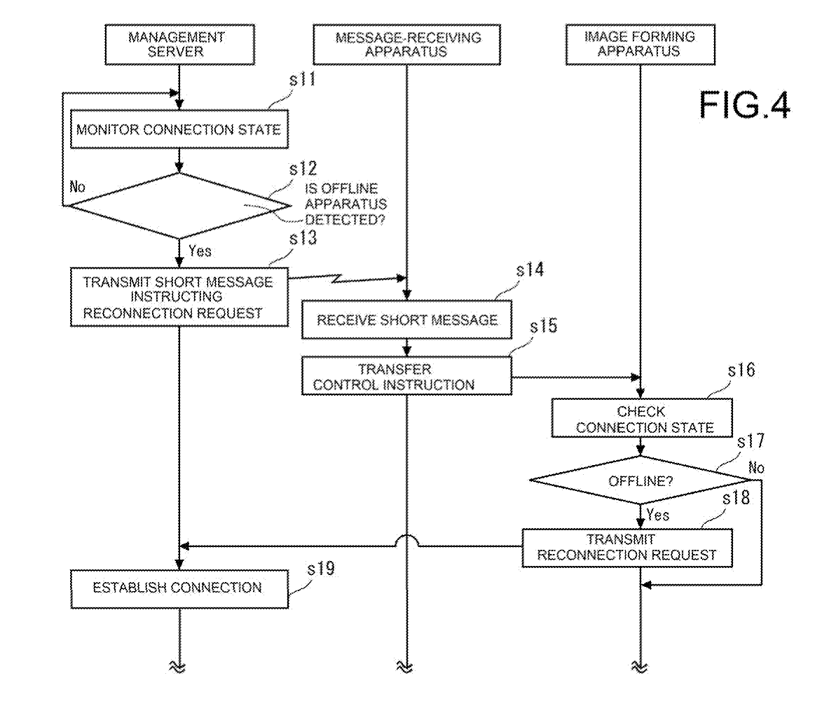

Next, the flow of the online recovery process when the management server 1 transmits a short message 70 related to a reconnection-request instruction will be explained with reference to FIG. 4.

The offline-apparatus-detecting unit 163 of the management server 1 monitors the connection state with the server-communication unit 14 for the image forming apparatuses 5 that are registered as management targets in the registration information 131 (step S11), and when the offline-apparatus-detecting unit 163 does not detect an offline apparatus (step S12: NO), processing returns to step S11.

However, when an offline apparatus is detected (step S12: YES), the recovery-requesting unit 164 creates specification information 71, a reconnection-request instruction, and a short message 70. The specification information 71 specifies the image forming apparatus 5 that is the transmission target. The reconnection-request instruction is a control instruction 72 for restoring an offline apparatus to an online state. The short message 70 includes an identification code 73 of the customer environment to which the offline apparatus belongs. Then, the recovery-requesting unit 164, by the message-transmitting unit 15 via the mobile telephone network 7, transmits the created short message 70 to the message-receiving apparatus 6 that is correlated with the offline apparatus (step S13).

The message-receiving apparatus 6 receives the short message 70 (step S14), and transfers a control instruction 72 based on the short message 70 to the image forming apparatus 5 via the customer network 4 (step S15).

At this time, when a specific image forming apparatus 5 is specified in the received short message 70 as the transmission target, the message-receiving apparatus 6 transfers the control instruction 72 to only the specified image forming apparatus 5 via the customer network 4. When an unspecific image forming apparatus 5 is specified in the short message 70 as the transmission target, the message-receiving apparatus 6 transfers the control instruction 72 to all of the image forming apparatuses 5 that are connected to the customer network 4.

When a control instruction 72 related to a reconnection request is received by the apparatus-communication unit 56 via the customer network 4, the message-processing unit 573 of the image forming apparatus 5 checks the connection state of the apparatus-communication unit 56 with the management server 1 (step S16).

When not offline (step S17: NO), or in other words, when online, the message-processing unit 573 determines that execution of the control instruction 72 is not necessary, and ends this processing. However, when offline (step S17: YES), the message-processing unit 573, by the reconnection-requesting unit 572, includes the identification code 73 in a reconnection request, and by the apparatus-communication unit 56, transmits the reconnection request to the management server 1 via the router 3 and the network 2 (step S18).

In other words, the case in which a control instruction 72 is transferred to all of the image forming apparatuses 5 that are connected to the customer network 4 by the message-receiving apparatus 6, and the case in which a control instruction 72 is transferred to only a specific image forming apparatus 5 as the transmission target will be explained. In either case, each message-processing unit 573 determines whether or not execution of the control instruction 72 is necessary, and the control instruction 72 is executed only when it is determined that execution is necessary.

When the reconnection request is received by the server-communication unit 14 of the management server 1, the reconnection-receiving unit 162 establishes a connection between the image forming apparatus 5 that transmitted the reconnection request and the server-communication unit 14 (step S19), and recovers the state to an online state.

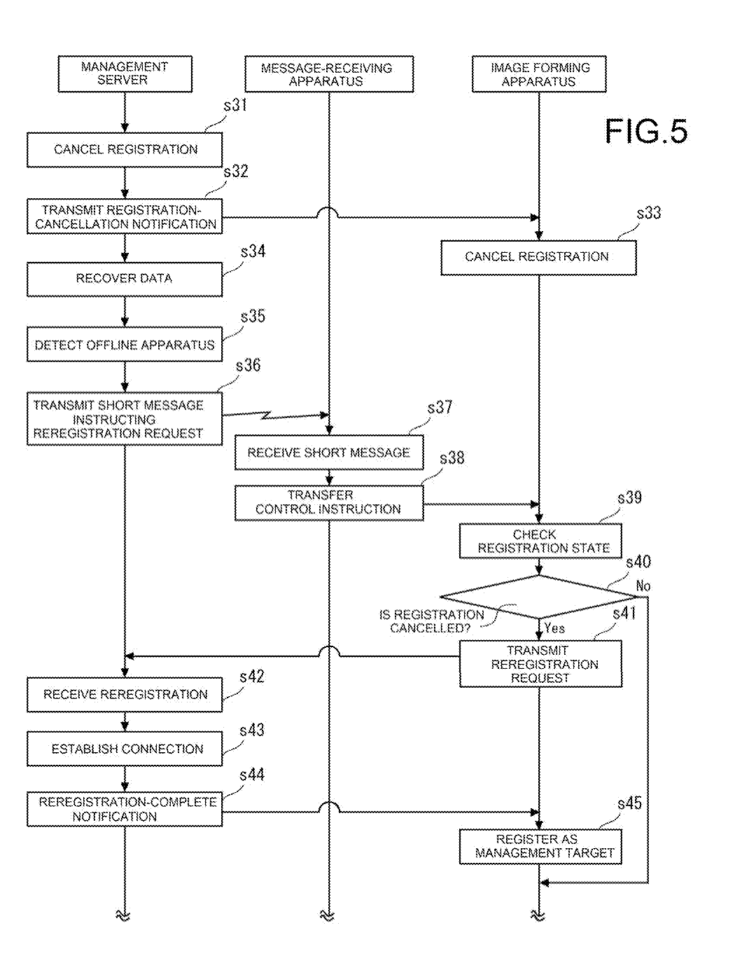

Next, the flow of the online recovery process when the management server 1 transmits a short message 70 related to a reregistration-request instruction will be explained with reference to FIG. 5.

The manager cancels registration of an image forming apparatus 5 that is a management target from the registration information 131 by mistake, such as a operation mistake or the like (step S31). As a result, a registration-cancellation notification is transmitted by the server-communication unit 14 of the management server 1 via the network 2 to the image forming apparatus 5 of which the registration is cancelled (step S32). The image forming apparatus 5 that receives the registration-cancellation notification cancels the registration of self apparatus in the registration information 531 as a management target (step S33).

The manager notices the operation mistake, and using backup data and the like executes data restoration of data such as the registration information 131 and the like (step S34). As a result, the image forming apparatus 5 of which registration is cancelled is registered in the registration information 131 as a management target, however, registration as a management target in the registration information 531 of that image forming apparatus 5 remains cancelled.

Therefore, this image forming apparatus 5 is detected as an offline apparatus by the offline-apparatus-detecting unit 163 (step S35). Continuing, the recovery-requesting unit 164, according to an operation and the like by the manager, creates a short message 70 of a control instruction 72 for requesting reregistration, and by the message-transmitting unit 15, transmits the short message 70 to the message-receiving apparatus 6 (step S36).

The message-receiving apparatus 6 receives the short message 70 (step S37), then via the customer network 4, transfers the control instruction 72 based on the short message 70 to the image forming apparatus 5 that is the transmission target (step S38).

The message-processing unit 573 of the image forming apparatus 5 that receives the control instruction 72 related to a reregistration request checks the registration state in the registration information 531 (step S39), when registration is not cancelled (step S40: NO), determines that execution of the control instruction 72 is not necessary and ends this process.

When registration is cancelled (step S40: YES), the message-processing unit 573, by the reregistration-requesting unit 571 includes an identification code 73 in the reregistration request, and by the apparatus-communication unit 56, transmits the reregistration request to the management server 1 via the router 3 and the network 2 (step S41).

The management server 1, by the server-communication unit 14 via the network 2, receives the reregistration request, and the reregistration-receiving unit 161 receives the reregistration (step S42) and reregisters the image forming apparatus 5 that transmitted the reregistration request in the registration information 131. Then, the reregistration-receiving unit 161 establishes a connection between the reregistered image forming apparatus 5 and the server-communication unit 14 (step S43), and sets the connection state to online. Next, the reregistration-receiving unit 161, by the server-communication unit 14 via the network 2, transmits a reregistration-complete notification to the reregistered image forming apparatus 5 (step S44).

The image forming apparatus 5 that receives a management-target notification by the server-communication unit 14 via the network 2 registers self apparatus in the registration information 531 as a management target (step S45), and then ends this process.

In this way, the image forming apparatus management system 100 of this embodiment is an image forming apparatus management system 100 that includes plural image forming apparatuses 5, and a management server 1 that via a network 2 remotely manages the image forming apparatuses 5 of the plural image forming apparatuses 5 that are registered as management targets, and further includes a message-management apparatus 6 that receives a control instruction 72 via a communication path (mobile telephone network 7) that is separate from the network 2; wherein the management server 1 includes: a server-communication unit 14 that is connected with the management-target image forming apparatuses 5 via the network 2; an offline-apparatus-detecting unit 163 that detects an image forming apparatus 5 of which the connection with the server-communication unit 14 becomes offline as an offline apparatus; and a recovery-requesting unit 164 that transmits a control instruction 72 to the message-receiving apparatus 6 via the communication path for causing the offline apparatus detected by the offline-apparatus-detecting unit 163 to recover the connection with the server-communication unit 14 to online; and a management-target image forming apparatus 5 includes an apparatus-communication unit 56 that is connected with the message-receiving apparatus 6 and that based on the control instruction 72 received by the message-receiving apparatus 6 communicates with the server-communication unit 14 via the network 2 and recovers the connection to online. Therefore, the management server 1 can transmit a control instruction 72 to an image forming apparatus 5 using a communication path that is separate from the network 2 even though it is not possible to transmit a control instruction 72 to an image forming apparatus 5 via the network 2. Consequently, even when an image forming apparatus 5 that is a management target of the management server 1 becomes offline, the image forming apparatus 5 can be recovered to online by remote control from the management server 1.

Incidentally, recovery-requesting unit 164 may cause the display unit 12 to display the image forming apparatus 5 detected by the offline-apparatus-detecting unit 163 as an offline apparatus, and receive a control instruction 72 for the offline apparatus by the operation unit 11. Moreover, the recovery-requesting unit 164 causes a manager terminal that is connected via the network 2 to display the offline apparatus that is detected by the offline-apparatus-detecting unit via a webpage. Together with that, the recovery-requesting unit 164 may receive a control instruction 72 for the offline apparatus from the manager terminal via a webpage. As a result, a manager can input a control instruction 72 for an offline apparatus.

Moreover, the recovery-requesting unit 164 may periodically transmit a short message 70 every specified amount of time such as every 30 minutes, every hour or the like until the offline apparatus detected by the offline-apparatus-detecting unit 163 is recovered to the online state. As a result, it is possible to continuously perform support until an offline apparatus is recovered to an online state.

Furthermore, the recovery-requesting unit 164 may hold transmission of the short message 70 until a specified amount of time has elapsed after the offline apparatus is detected by the offline-apparatus-detecting unit 163, and then transmit the short message 70 after the specified amount of time has elapsed. This is because there are cases in which the offline apparatus autonomously transmits a reconnection request and recovers the connection state to online. Incidentally, in this case, the held short message 70 is deleted. In addition, the specified amount of time may be an amount of time that corresponds to the number of retries of the reconnection request by the offline apparatus. As a result, there are cases in which the offline apparatus autonomously recovers the connection state to online, so it is possible to suppress the number of times the short message 70 is transmitted.

Moreover, the offline-apparatus-detecting unit 163 may accumulate transition patterns in the server-storage unit 13 of transitions to online or offline for the connection state with the server-communication unit 14 for every image forming apparatus 5 registered as a management target. Then, the recovery-requesting unit 164, based on the accumulated transition patterns, may predict a standardized online period for each of the image forming apparatuses 5 registered as a management target. Then, only when the offline apparatus detected by the offline-apparatus-detecting unit 163 is offline during the predicted online period, the recovery-requesting unit 164 may transmit the short message 70. As a result, a short message 70 can be transmitted to an image forming apparatus 5 that cannot autonomously be recovered to an online state.

Furthermore, in the embodiment described above, the recovery-requesting unit 164 transmits a control instruction 72 as a short message 70 to the message-receiving apparatus 6 via the mobile telephone network 7 as a communication path that is different than the network 2, however, the communication path that is different than the network 2 is not limited to this. For example, each of the recovery-requesting unit 164 and the message-receiving apparatus 6 may have a modem, may generate a control instruction 72 to a facsimile signal via a public telephone network, and transmit and receive them.

The technology according to the present disclosure is not limited to the embodiments described above, and needless to say various modifications are possible within a range that does not depart from the gist of the present disclosure.

Incidentally, in typical technology, when reconnection of an image forming apparatus fails a specified number of times, or when registration is cancelled from the management server due to an error such as an operation mistake or the like, the image forming apparatus remains in an offline state. The connection with the image forming apparatus is disconnected, so the management server is not able to recover the image forming apparatus to an online state by remote control via a normal network. Therefore, for an image forming apparatus that cannot be recovered to an online state, it is necessary to request a customer to restart the image forming apparatus, or to dispatch a service technician to perform work of setting the image forming apparatus, which is troublesome.

With the technology according to the present disclosure, when an image forming apparatus that is a management target of a management server becomes offline, the image forming apparatus can be recovered to an online state by remote control from the management server.

What is claimed is:

1. An image forming apparatus management system, comprising plural image forming apparatuses, and a management server that remotely manages, via a network, image forming apparatuses of the plural image forming apparatuses that are registered as management targets, and further comprising
a message-receiving apparatus for receiving control instructions from the management server via a communication path that is separate from the network, wherein
the management server comprises:
a server-communication unit that is connected with the management-target image forming apparatuses via the network;
an offline-apparatus-detecting unit that detects an image forming apparatus of which the connection with the server-communication unit is offline as an offline apparatus; and
a recovery-requesting unit that transmits a control instruction to the message-receiving apparatus via the communication path for causing the offline apparatus detected by the offline-apparatus-detecting unit to recover the connection with the server-communication unit to an online state;
the image forming apparatuses that are the management targets are connected to the message-receiving apparatus, and comprise:
an apparatus-communication unit that, based on the control instruction that is received by the message-receiving apparatus, communicates with the server-communication unit via the network and recovers the image forming apparatus to an online state.

2. The image forming apparatus management system according to claim 1, wherein
the communication path is a mobile telephone network;
a telephone number of a mobile telephone line is assigned to each of the management server and the message-receiving apparatus; and
the recovery-requesting unit transmits the control instruction as a short message to the message-receiving apparatus.

3. The image forming apparatus management system according to claim 1, wherein
the offline-apparatus-detecting unit monitors the connections states between the image forming apparatuses registered as the management targets and the server-communication unit; and
the recovery-requesting unit periodically transmits the control instruction via the communication path to the message-receiving apparatus until the offline apparatus detected by the offline-apparatus-detecting unit is recovered to being online.

4. The image forming apparatus management system according to claim 1, wherein
the recovery-requesting unit transmits the control instruction via the communication path to the message-receiving apparatus after a specified amount of time elapses from when the offline apparatus is detected by the offline-apparatus-detecting unit.

5. The image forming apparatus management system according to claim 1, wherein
the management server comprises
a server-storage unit that accumulates transition patterns for the transition of the connection between the image forming apparatuses registered as management targets and the server-communication unit to online or offline; wherein
the recovery-requesting unit limits the offline apparatus that is the transmission target of the control instruction based on the transition pattern accumulated in the server-storage unit.

6. The image forming apparatus management system according to claim 1, wherein
the message-receiving apparatus is connected to a customer network that is connected to each of the plural image forming apparatuses; and
transfers control instructions received via the communication path to the image forming apparatuses via the customer network.

7. An image forming apparatus management method by an image forming apparatus management system that comprises plural image forming apparatuses, and a management server that remotely manages, via a network, image forming apparatuses of the plural image forming apparatuses that are registered as management targets, wherein
the management server is connected with the management-target image forming apparatuses via the network;
detects an image forming apparatus of which the connection via the network is offline as an offline apparatus; and
transmits a control instruction to a message-receiving apparatus via a communication path that is separate from the network for causing the offline apparatus detected to recover the connection to an online state;
the control instruction is received by the message-receiving apparatus via a communication path that is separate from the network; and
the management-target image forming apparatuses are connected to the message-receiving apparatus, and
based on the control instructions received by the message-receiving apparatus, communicate with the management server via the network and recover the connection state to an online state.
